(19) United States
(12) Patent Application Publication
(10) Pub. No.: US 2025/0165666 A1
(43) Pub. Date: May 22, 2025

(54) SYSTEM AND METHOD FOR MODELING HYBRID SENSOR

(71) Applicant: Korea Electronics Technology Institute, Seongnam-si (KR)

(72) Inventors: Sang Yub LEE, Yongin-si (KR); Inpyo CHO, Yongin-si (KR); Jaekyu LEE, Yongin-si (KR)

(21) Appl. No.: 18/657,009

(22) Filed: May 7, 2024

(30) Foreign Application Priority Data
Nov. 16, 2023 (KR) 10-2023-0159607

(51) Int. Cl. G06F 30/20

(52) U.S. Cl. CPC G06F 30/20

(57) ABSTRACT

A method of modeling a hybrid sensor is proposed. The method may include receiving information on at least one physical sensor that is disposed within a target space, disposing at least one virtual sensor within the target space, and obtaining sensing data of the virtual sensor and converting the sensing data into visualization information. The method may also include analyzing matching between an additionally disposed physical sensor and the virtual sensor when the physical sensor is additionally disposed at a location of any one of the disposed virtual sensors. The method may further include correcting the weight of the sensing data of the virtual sensor based on results of the analysis of the matching.

### CROSS-REFERENCE TO RELATED APPLICATION

This application claims priority to and the benefit of Korean Patent Application No. 10-2023-0159607 filed on Nov. 16, 2023, the disclosure of which is incorporated herein by reference in its entirety.

### BACKGROUND

### Technical Field

The present disclosure relates to a system and method for modeling a hybrid sensor.

### Description of Related Technology

A place at which a sensor is installed is basically determined by physical restrictions. Such restrictions may be related to a structure, safety regulations, and environmental conditions for a facility or a space. Accordingly, a sensor may have a difficulty in obtaining accurate state information. For example, the sensor needs to be installed at a specific location, but it may be difficult to approach the location or to collect data.

### SUMMARY

One aspect is a system and method for modeling a hybrid sensor, which can derive an optimal sensor arrangement within a space or equipment by using a hybrid modeling scheme and may be applied to an artificial intelligence model capable of detecting an abnormal state or controlling an operation in a danger state by securing high-fidelity data.

However, aspects of the present disclosure to be achieved are not limited to the aspects disclosed herein, and other aspects may be present.

Another aspect is a method of modeling a hybrid sensor that includes receiving information on at least one physical sensor that is disposed within a target space, disposing at least one virtual sensor within the target space, obtaining sensing data of the virtual sensor and converting the sensing data into visualization information, analyzing matching between an additionally disposed physical sensor and the virtual sensor when the physical sensor is additionally disposed at a location of any one of the disposed virtual sensors, and correcting the weight of the sensing data of the virtual sensor based on results of the analysis of the matching.

Another aspect is a system for modeling a hybrid sensor includes a communication module configured to receive sensing data of at least one physical sensor that is disposed within a target space, memory in which a program for performing a modeling of a hybrid sensor by disposing a virtual sensor in the target space has been stored, and a processor configured to, by executing the program storing the memory, obtain sensing data of at least one virtual sensor after disposing the at least one virtual sensor in the target space, convert the sensing data into visualization information, analyze matching between an additionally disposed physical sensor and the virtual sensor when a physical sensor is additionally disposed at a location of any one of the disposed virtual sensors, and correct the weight of the sensing data of the virtual sensor based on a result of the analysis of the matching.

Another method and another system for implementing an embodiment of the present disclosure, and a computer-readable recording medium on which a computer program for executing the method has been recorded may be further provided.

According to various embodiments of the present disclosure, the arrangement and construction of sensors can be optimized and efficiency of a space or equipment can be improved by presenting a combination of sensors which may be installed within a space or equipment and providing an optimal construction method.

Furthermore, according to various embodiments of the present disclosure, an error between actual data and virtual data can be reduced and data accuracy of a virtual sensor can be increased by using a hybrid modeling scheme. Accordingly, a space or equipment can be accurately monitored and analyzed by generating high-quality data, such as image data.

Furthermore, according to various embodiments of the present disclosure, a method of maximizing the sensing area of a sensor can be provided while minimizing construction costs. Accordingly, a sensor can be disposed within a space or equipment in an economical manner, and thus cost efficiency can be achieved.

In addition, various embodiments of the present disclosure has advantages in that the abnormality of equipment or a space can be rapidly sensed and handled and the stability of a system can be improved by providing a method of determining whether equipment or a space are abnormal by using a physical sensor that has been constructed.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a diagram for describing a conventional method of installing sensors.

FIG. 2 is a block diagram of a construction of a system for modeling a hybrid sensor according to an embodiment of the present disclosure.

FIG. 3 is a flowchart of a method of modeling a hybrid sensor according to an embodiment of the present disclosure.

FIG. 4 is a diagram illustrating an example in which virtual sensors have been disposed in an embodiment of the present disclosure.

FIG. 5 is a diagram illustrating another embodiment in which virtual sensors have been disposed in an embodiment of the present disclosure.

FIG. 6 is a diagram for describing an integrated virtual sensor in an embodiment of the present disclosure.

FIG. 7 is a diagram illustrating an example of hybrid modeling according to an embodiment of the present disclosure.

FIG. 8 is a diagram for describing an example of matching analysis in an embodiment of the present disclosure.

FIG. 9 is a diagram for describing contents which check matching between a virtual sensor and a physical sensor in an embodiment of the present disclosure.

FIG. 10 is a diagram for describing an optimized setting method for a virtual sensor and a physical sensor in an embodiment of the present disclosure.

FIG. 11 is a diagram illustrating an example of optimized results of a virtual sensor and a physical sensor in an embodiment of the present disclosure.

FIG. 12 is a diagram illustrating an overall function which is provided by an embodiment of the present disclosure.

### DETAILED DESCRIPTION

The number of sensors determines a sensing area, and has a direct influence on a construction and operating expenses for a system. If more sensors are installed, more areas may be sensed, but this may increase installation and maintenance and management costs. Accordingly, in order to economically operate the system, an optimal number of sensors need to be determined.

In particular, if a situation for a space or equipment is changed, an optimal number and locations of sensors also need to be changed. For example, if an environment condition is changed or new equipment is introduced, an optimal arrangement of sensors needs to be update. Accordingly, it is important to flexibly maintain the optimal arrangement of sensors.

In addition, most of sensors generate numerical data. In general, the numerical data are represented as numbers or values. Some sensors may generate image data. Resolution of an image may be different depending on performance and a technology of a sensor. In this case, since an image having low resolution may miss detailed information, such a limit needs to be considered.

Such problems are objects for managing and optimizing the installation and operation of sensors. There is a need for a method for overcoming such problems and efficiently operating a system through sensor arrangement optimization and data analysis.

Advantages and characteristics of the present disclosure and a method for achieving the advantages and characteristics will become apparent from the embodiments described in detail later in conjunction with the accompanying drawings. However, the present disclosure is not limited to embodiments disclosed hereinafter, but may be implemented in various different forms. The embodiments are merely provided to complete the present disclosure and to fully notify a person having ordinary knowledge in the art to which the present disclosure pertains of the category of the present disclosure. The present disclosure is merely defined by the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element. Throughout the specification, the same reference numerals denote the same elements. “And/or” includes each of mentioned elements and all combinations of one or more of mentioned elements. Although the terms “first”, “second”, etc. are used to describe various components, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

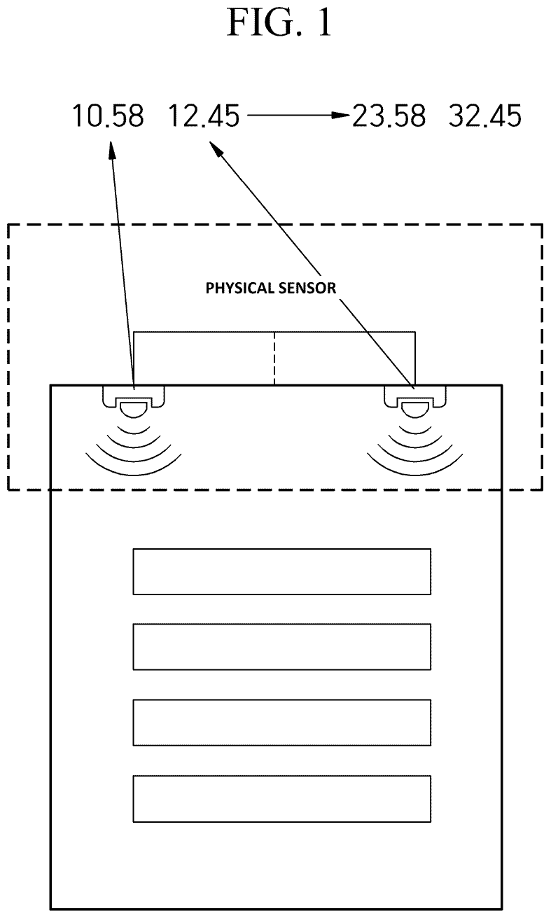

FIG. 1 is a diagram for describing a conventional method of installing sensors.

Conventionally, there is a limit in the collection of data according to a location at which a sensor is installed and the state of the sensor. If two sensors are to be installed in a target space as illustrated in FIG. 1, there is a need for a process of obtaining sensor values from the two sensors, sensing a change in the sensor values, and installing the two sensors while checking the motion states of the sensors. However, if a sensor is installed by using such a method, there are problems in that it is difficult to check an overall situation, there is a blind spot which cannot be sensed by the sensor, and it is difficult to previously handle a sudden change in the sensor value.

To increase the number of sensors or use an expensive sensor having a wide sensing area is the existing approach method for solving such problems. However, such a method cannot solve a problem for optimization in terms of costs and securing data.

That is, the method of increasing the number of sensors can improve the collection of data, but requires additional costs and may make it difficult to additionally install a sensor at a proper location in all situations. Accordingly, a data shortage problem may still remain in some areas.

Furthermore, an expensive sensor may have a wide sensing area, but requires high costs that much. If such a sensor is used in a situation in which a wide sensing area is not necessary, waste occurs.

An embodiment of the present disclosure for solving such a problem has an object of optimizing sensor data and improving the accuracy of a sensor for a space or equipment. In particular, the accuracy of a sensor can be increased by combining actual data and modeling results through a method of combining and mutually supplementing physical sensor data and a software physical engine for modeling an operation of a physical system by using a “hybrid modeling” scheme.

Furthermore, according to an embodiment of the present disclosure, an optimal number and locations of sensors for a space or equipment can be determined by using a sensor to which hybrid modeling has been applied.

Furthermore, an output value generated by a physical sensor may be mapped to or converted into image data. The generated image data may be used as an input to an artificial intelligence model (e.g., a deep learning network), and can improve the accuracy of the data. Such utilization of image data may help to identify a pattern or characteristics through visual information.

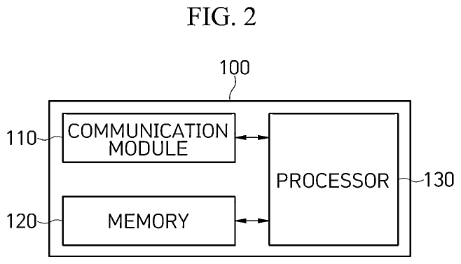

Hereinafter, a system for modeling a hybrid sensor according to an embodiment of the present disclosure is described with reference to FIG. 2.

FIG. 2 is a block diagram of a construction of a system 100 for modeling a hybrid sensor according to an embodiment of the present disclosure.

The system 100 for modeling a hybrid sensor according to an embodiment of the present disclosure includes a communication module 110, memory 120, and a processor 130.

The communication module 110 receives sensing data of at least one physical sensor that is disposed within a target space. The communication module 110 may include both a wired communication module and a wireless communication module. The wired communication module may be implemented as a power line communication device, a telephone line communication device, cable home (MoCA), Ethernet, IEEE1294, an integrated wired home network, or an RS-485 controller. Furthermore, the wireless communication module may be constructed as a module for implementing a function, such as a wireless LAN (WLAN), Bluetooth, an HDR WPAN, UWB, ZigBee, impulse radio, a 60 GHz WPAN, binary-CDMA, a wireless USB technology, a wireless HDMI technology, 5th generation (5G) communication, long term evolution-advanced (LTE-A), long term evolution (LTE), or wireless fidelity (Wi-Fi).

The memory 120 stores a program for performing the modeling of a hybrid sensor by disposing a virtual sensor within a target space. The processor 130 executes the program stored in the memory 120. In this case, the memory 120 collectively refers to a nonvolatile storage device that continuously retains information stored therein although power is not supplied thereto and a volatile storage device.

For example, the memory 120 may include NAND flash memory such as a compact flash (CF) card, a secure digital (SD) card, a memory stick, a solid-state drive (SSD), and a micro SD card, a magnetic computer memory device such as a hard disk drive (HDD), and an optical disc drive such as CD-ROM and DVD-ROM.

By executing the program stored in the memory 120, the processor 130 performs a series of processes of adjusting the weight of sensing data of a virtual sensor and tuning the virtual sensor by determining the design, arrangement, the generation of data, data visualization, and matching with actual sensing data of the virtual sensor through hybrid modeling. Furthermore, the processor 130 optimizes the virtual sensor on which the tuning has been completed and a physical sensor, and performs data analysis in the optimized state.

The processor 130 may use at least one of machine learning, a neural network, or a deep learning algorithm as an artificial intelligence algorithm. For example, the processor 130 may use at least one of machine learning, a neural network, or a deep learning algorithm as the artificial intelligence algorithm. Examples of the neural network may include models, such as a convolutional neural network (CNN), a deep neural network (DNN), and a recurrent neural network (RNN).

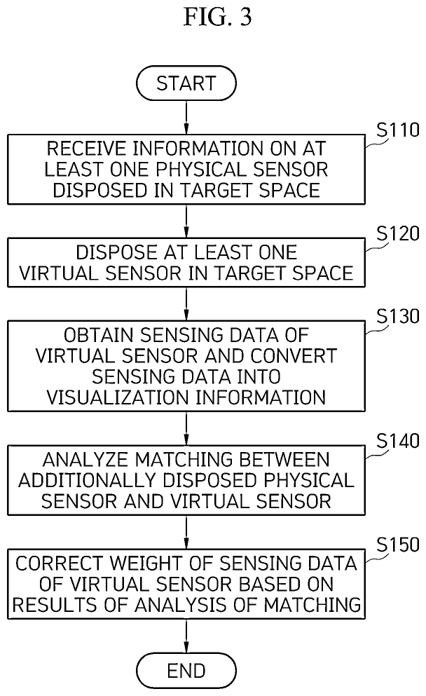

Hereinafter, a method that is performed by the system 100 for modeling a hybrid sensor according to an embodiment of the present disclosure is described with reference to FIGS. 3 to 12.

FIG. 3 is a flowchart of a method of modeling a hybrid sensor according to an embodiment of the present disclosure.

First, information on at least one physical sensor that has been disposed in a target space is received (S110). At least one virtual sensor is disposed in the target space (S120).

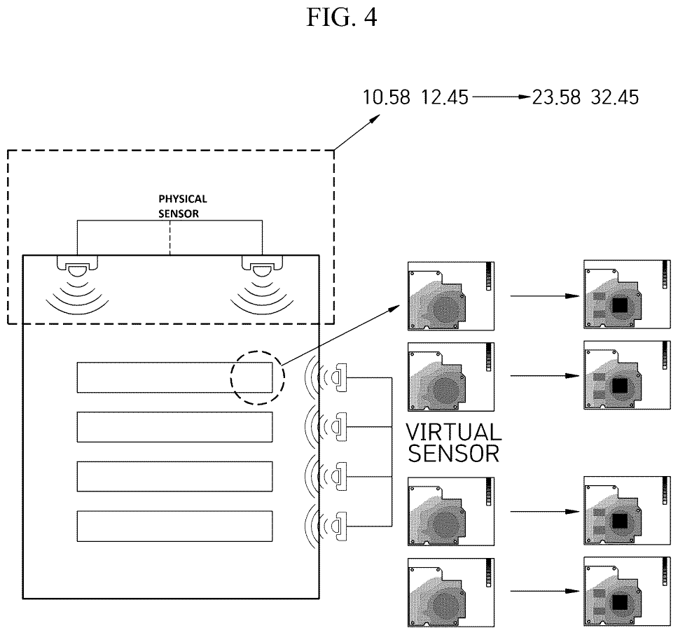

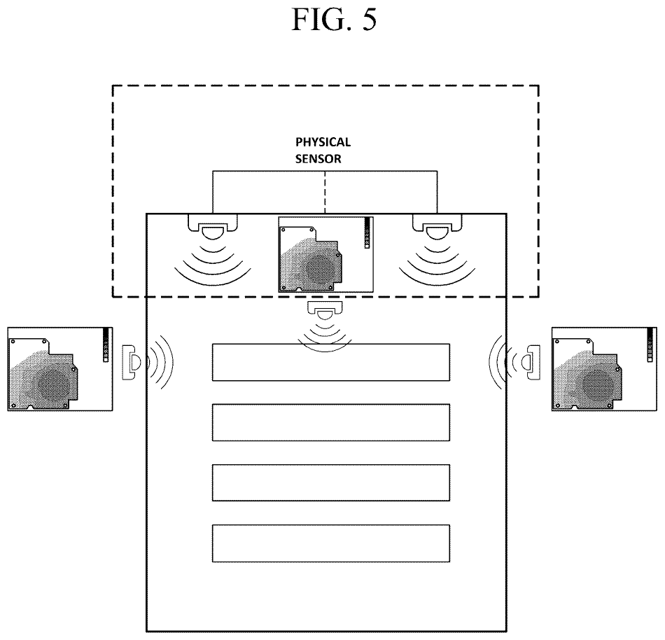

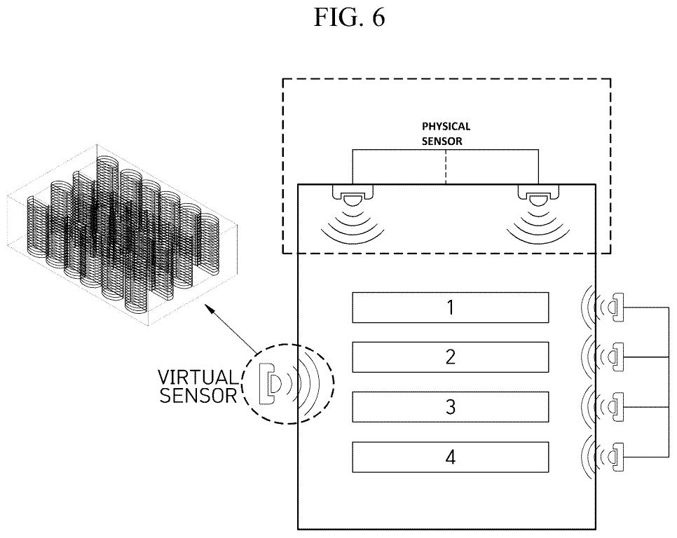

FIG. 4 is a diagram illustrating an example in which virtual sensors have been disposed in an embodiment of the present disclosure. FIG. 5 is a diagram illustrating another embodiment in which virtual sensors have been disposed in an embodiment of the present disclosure. FIG. 6 is a diagram for describing an integrated virtual sensor in an embodiment of the present disclosure.

In an embodiment of the present disclosure, a virtual sensor may be constructed in a target space in which a physical sensor has been disposed through hybrid modeling. In this case, the hybrid modeling is a modeling scheme capable of reducing the inclination of data by effectively combining actual data and virtual data and increasing matching between the two types of data. The hybrid modeling can improve the accuracy and usefulness of data and enables better understanding and prediction for a real-world situation.

As an embodiment, a virtual sensor is not a physical sensor, and is a virtual sensor that obtains information through computer simulations and data analysis. If such a simulation and data analysis technology is used in a computer-aided engineering (CAE) field, a thermal conduction state, a temperature change, or a change in an electrical characteristic can be visualized and predicted by using information on a circuit in a target space (or an installed device) and information on a printed circuit board (PCB) through a scheme, such as a computational fluid dynamics (CFD) or finite element analysis (FEA).

A virtual sensor in an embodiment of the present disclosure may operate as follows. First, after a mathematical model for a target space (e.g., a specific system or environment) in which a virtual sensor will be used is derived, simulations are performed through a physical and engineering scheme, such as the CFD or the FEA, based on the mathematical model. Such simulations are for predicting a temperature, pressure, or electrical characteristic of the target space.

Next, in an embodiment of the present disclosure, sensing data of the virtual sensor are obtained and converted into visualization information (S130). That is, the state of the target space may be understood and visually represented by visualizing the results of the simulations.

For example, No. 1 equipment (i.e., a target space) illustrated in FIG. 4 may be converted into visual information, such as that illustrated in FIG. 4. In this case, a virtual sensor may obtain data from various parts in view of its characteristic, and thus can secure all data of the No. 1 equipment through various arrangements, such as those illustrated in FIG. 5.

Furthermore, in an embodiment of the present disclosure, as illustrated in FIG. 6, a plurality of virtual sensors corresponding to a plurality of target spaces 1, 2, 3, and 4, respectively, may be disposed. In this case, the plurality of virtual sensors may be converted into an integrated virtual sensor. Integrated sensing data for all of the plurality of target spaces may be obtained from the integrated virtual sensor.

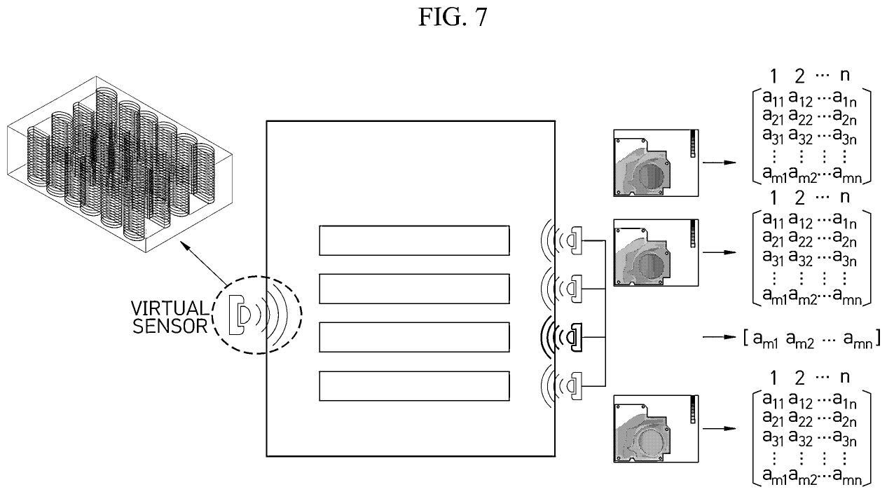

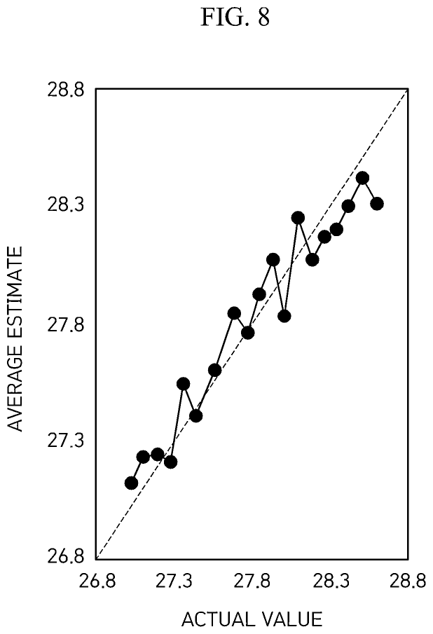

FIG. 7 is a diagram illustrating an example of hybrid modeling according to an embodiment of the present disclosure. FIG. 8 is a diagram for describing an example of matching analysis in an embodiment of the present disclosure.

Next, if a physical sensor is additionally disposed at the location of any one of virtual sensors that have been disposed, matching between the additionally disposed physical sensor and the virtual sensor is analyzed (S140).

If sensing data of the virtual sensor have been generated and secured through various simulations and modeling schemes, in order to check matching between data that have been generated by the virtual sensor, the physical sensor may be applied to at least one of the locations of the virtual sensors. The physical sensor collects data in the real world, and performs a process of comparing the collected data with the data of the virtual sensor.

For such a matching comparison, visualization data of the virtual sensor are converted into a sensing value having a one-dimensional form. A correlation between the converted sensing value and a sensing value of the additionally disposed physical sensor, which has a one-dimensional form, is analyzed. This is for facilitating a comparison and analysis of data. How much two data sets of the virtual sensor and the physical sensor are similar to each other is measured through the correlation analysis.

Next, the weight of the sensing data of the virtual sensor is corrected based on the results of the analysis of the matching (S150).

After a difference between the data of the virtual sensor and the data of the physical sensor is checked through the correlation analysis, the weights of some values of the data of the virtual sensor are adjusted in order to correct the difference. The precision of the data of the virtual sensor can be improved and the data of the virtual sensor can be corrected to be more accurately matched with the actual data through such an adjustment of the weights.

FIG. 8 illustrates the results of corrections of a virtual sensor. After weight adjustment and data corrections are performed, results that are more matched with data of a physical sensor can be obtained by correcting the results of the virtual sensor.

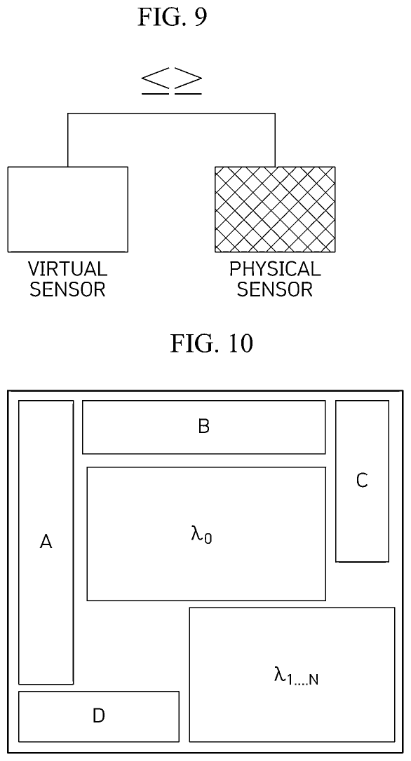

Hereinafter, an optimization process that is performed in a hybrid modeling method according to an embodiment of the present disclosure is described in detail with reference to FIGS. 9 to 11.

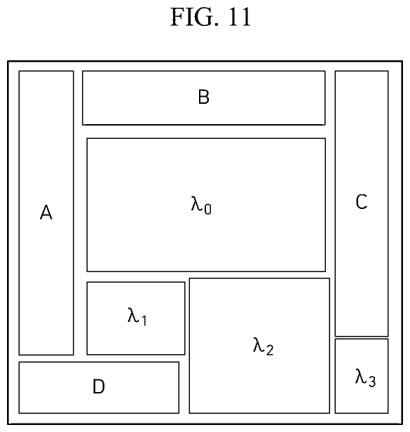

FIG. 9 is a diagram for describing contents which check matching between a virtual sensor and a physical sensor in an embodiment of the present disclosure. FIG. 10 is a diagram for describing an optimized setting method for a virtual sensor and a physical sensor in an embodiment of the present disclosure. FIG. 11 is a diagram illustrating an example of optimized results of a virtual sensor and a physical sensor in an embodiment of the present disclosure.

In an embodiment of the present disclosure, a process of optimizing the arrangement of a physical sensor and a virtual sensor in a target space may be performed. Such an optimization process is for optimizing the number and locations of sensors with respect to a given target space, and an object of reducing costs and optimizing performance by efficiently using a space as much as possible and minimizing a required number of sensors.

To this end, in an embodiment of the present disclosure, a target space is modeled in a predetermined form, and the location of a virtual sensor that has been previously prepared is matched with the location of a physical sensor by considering the location of a physical sensor. Accordingly, how the physical sensor and the virtual sensor can be combined can be checked.

Next, the prepared virtual sensor and the physical sensor are disposed in each face of the modeled target space. In this case, the virtual sensor and the physical sensor may be disposed so that the area of the virtual sensor and the physical sensor that are disposed in each face of the modeled target space becomes a maximum.

Next, at least one virtual sensor is additionally disposed in an empty area of the modeled target space. Referring to FIG. 10, the four faces of the modeled target space are filled with a combination of the virtual sensor and the physical sensor like A, B, C, and D. A virtual sensor λ is additionally disposed in order to use the empty space as much as possible without overlapping. In this case, in an embodiment of the present disclosure, each correlation between the prepared virtual sensor and the physical sensor may be calculated, and the virtual sensor may be additionally disposed in the empty area based on the correlations.

Furthermore, in an embodiment of the present disclosure, after the virtual sensor is additionally disposed, whether an empty area is present in the modeled target space is determined. If the empty area is present as a result of the determination, after each correlation between the additionally disposed virtual sensor, and the prepared virtual sensor and the physical sensor is calculated, a virtual sensor may be additionally disposed in the empty area based on the correlations.

That is, in an embodiment of the present disclosure, after the correlation is analyzed by further considering the added virtual sensor in addition to the correlation between the existing virtual sensor and the physical sensor, the virtual sensor may be additionally disposed.

For example, in FIG. 11, a virtual sensor λ₀ may be additionally disposed by considering a correlation |A−B|=λ₀ between sensors A and B. The virtual sensor may be additionally set like |A−D|=λ₁, |λ₀−λ₂|=λ₁, |C−λ₂|=λ₃ by considering such a correlation. In an embodiment of the present disclosure, the correlation may include the location, size, sensing performance, or mutual influence of a sensor.

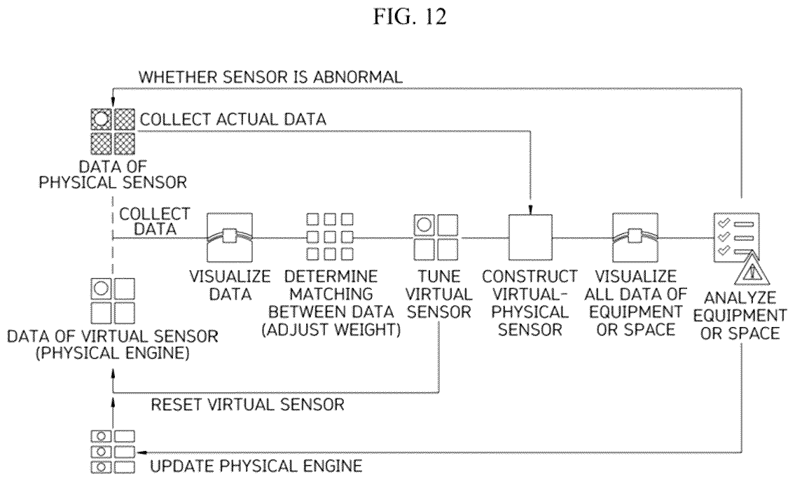

FIG. 12 is a diagram illustrating an overall function which is provided by an embodiment of the present disclosure.

In the method of modeling a hybrid sensor according to an embodiment of the present disclosure, a function illustrated in FIG. 12 may be performed according to a presented procedure and flow. An embodiment of the present disclosure may be used to optimize equipment or a space by checking whether a physical sensor is abnormal by using a virtual sensor and precisely analyzing data.

First, a virtual sensor is designed, and required data are generated. The virtual sensor simulates various scenarios and situations through the CAE) and modeling, and may generate data. The generated data may be represented by visualizing the results of the simulations in order to be easily understood.

Thereafter, accuracy can be improved by determining matching between the generated data of the virtual sensor and data of a physical sensor and correcting the data by adjusting the weight of the virtual sensor. The virtual sensor on which tuning has been completed generates data that are necessary to provide accurate state information.

Furthermore, the virtual sensor on which tuning has been completed and a physical sensor are constructed within equipment or a space. In this case, in order to determine an optimal location and arrangement, the virtual sensor and the physical sensor may be disposed by using an optimization method. The optimization method operates as a method of effectively monitoring the entire area by adjusting the number, locations, and sensing ranges of sensors.

Furthermore, data that have been collected from the virtual sensor and the physical sensor constructed within the equipment or the space may be integrated and visualized. The state of the equipment or the space can be monitored, and whether the equipment or the space is abnormal and performance can be checked by analyzing the visualized data.

When all of the results of the analysis are derived, a physical engine model can be reinforced by applying the analysis results to the virtual sensor again. The results of the analysis may be used to determine whether the physical sensor is abnormal by applying the results of the analysis to the physical sensor. Accordingly, the state of the equipment or the space can be evaluated and a problem can be solved, by using both the accuracy of the virtual sensor and the reliability of the physical sensor.

In the aforementioned description, each of steps S110 to S150 may be further divided into additional steps or the steps may be combined into smaller steps depending on an implementation example of the present disclosure. Furthermore, some of the steps may be omitted, if necessary, and the sequence of the steps may be changed. Furthermore, the contents of FIG. 1 and the contents of FIGS. 2 to 12 are mutually applied.

The method of modeling a hybrid sensor according to an embodiment of the present disclosure may be implemented as a program (or an application) in order to be executed by being combined with a server, that is, hardware, and may be stored in a medium.

The aforementioned program may include a code coded in a computer language, such as C, C++, JAVA, or a machine language which is readable by a processor (CPU) of a computer through a device interface of the computer in order for the computer to read the program and execute the methods implemented as the program. Such a code may include a functional code related to a function, etc. That defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The stored medium means a medium, which semi-permanently stores data and is readable by a device, not a medium storing data for a short moment like a register, cache, or a memory. Specifically, examples of the stored medium include read only memory (ROM), random access memory (RAM), CD-ROM, a magnetic tape, a floppy disk, optical data storage, etc., but the present disclosure is not limited thereto. That is, the program may be stored in various recording media in various servers which may be accessed by a computer or various recording media in a computer of a user. Furthermore, the medium may be distributed to computer systems connected over a network, and a code readable by a computer in a distributed way may be stored in the medium.

The steps of the method or algorithm described in relation to the embodiments of the present disclosure may be directly implemented as hardware, may be implemented as a software module executed by hardware, or may be implemented by a combination of them. The software module may reside in RAM, ROM, erasable programmable ROM (EPROM), electrically erasable programmable ROM (EEPROM), flash memory, a hard disk, a detachable disk, CD-ROM, or a computer-readable medium having a given form, which is well known in the field to which the present disclosure pertains.

Although the embodiments of the present disclosure have been described with reference to the accompanying drawings, a person of ordinary knowledge in the art to which the present disclosure pertains may understand that the present disclosure may be implemented in other detailed forms without changing the technical spirit or essential characteristics of the present disclosure. Accordingly, it is to be understood that the aforementioned embodiments are only illustrative, but are not limitative in all aspects.

What is claimed is:

1. A computer-implemented method of modeling a hybrid sensor, the method comprising:
receiving information on at least one physical sensor disposed within a target space;
disposing at least one virtual sensor within the target space;
obtaining sensing data of the virtual sensor and converting the sensing data into visualization information;
analyzing matching between an additionally disposed physical sensor and the virtual sensor in response to the physical sensor being additionally disposed at a location of any one of the disposed virtual sensors; and
correcting a weight of the sensing data of the virtual sensor based on results of the analysis of the matching.

2. The method of claim 1, wherein:
the disposing comprises disposing a plurality of virtual sensors in a plurality of target spaces, respectively, and
obtaining the sensing data of the virtual sensor and converting the sensing data comprises:
converging the plurality of virtual sensors into an integrated virtual sensor, and
obtaining integrated sensing data for all of the plurality of target spaces from the integrated virtual sensor.

3. The method of claim 1, wherein the analyzing comprises:
converting the visualization data of the virtual sensor into a sensing value having a one-dimensional form; and
analyzing a correlation between the converted sensing value and a sensing value of the additionally disposed physical sensor, which has a one-dimensional form.

4. The method of claim 1, further comprising optimizing the arrangement of the physical sensor and the virtual sensor in the target space.

5. The method of claim 4, wherein the optimizing comprises:
modeling the target space in a predetermined form;
matching a location of the virtual sensor that has been previously prepared and a location of the physical sensor by considering the location of the physical sensor;
disposing the prepared virtual sensor and the physical sensor in each face of the modeled target space; and
additionally disposing at least one virtual sensor in an empty area of the modeled target space.

6. The method of claim 5, wherein disposing the prepared virtual sensor and the physical sensor comprises disposing the prepared virtual sensor and the physical sensor so that an area of the virtual sensor and the physical sensor disposed in each face of the modeled target space becomes a maximum.

7. The method of claim 5, wherein the additionally disposing comprises:
calculating each correlation between the prepared virtual sensor and the physical sensor; and
additionally disposing the virtual sensor in the empty area based on the correlations.

8. The method of claim 7, wherein additionally disposing the at least one virtual sensor in the empty area of the modeled target space comprises:
determining whether an empty area is present in the modeled target space after additionally disposing the virtual sensor;
calculating each correlation between the additionally disposed virtual sensor, and the prepared virtual sensor and the physical sensor when the empty area is present based on a result of the determination; and
additionally disposing the virtual sensor in the empty area based on the correlations.

9. A system for modeling a hybrid sensor, comprising:
a communication module configured to receive sensing data of at least one physical sensor that is disposed within a target space;
a memory storing instructions; and
a processor configured to execute the instructions to:
obtain sensing data of at least one virtual sensor after disposing the at least one virtual sensor in the target space,
convert the sensing data into visualization information,
analyze matching between an additionally disposed physical sensor and the virtual sensor when a physical sensor is additionally disposed at a location of any one of the disposed virtual sensors, and
correct a weight of the sensing data of the virtual sensor based on a result of the analysis of the matching.

10. The system of claim 9, wherein the processor is configured to:
model the target space in a predetermined form,
match a location of the virtual sensor that has been previously prepared and a location of the physical sensor by considering the location of the physical sensor,
dispose the prepared virtual sensor and the physical sensor in each face of the modeled target space, and
additionally dispose at least one virtual sensor in an empty area of the modeled target space.

11. The system of claim 10, wherein the processor is configured to dispose the prepared virtual sensor and the physical sensor so that an area of the virtual sensor and the physical sensor disposed in each face of the modeled target space becomes a maximum.

12. The system of claim 9, wherein the processor is configured to:
calculate each correlation between the prepared virtual sensor and the physical sensor, and
additionally dispose the virtual sensor in the empty area based on the correlations.
